(19) United States
(12) Patent Application Publication
(10) Pub. No.: US 2026/0347268 A1
(43) Pub. Date: Nov. 5, 2026

(54) CERAMIC SUBSTRATE AND METHOD FOR MANUFACTURING SAME

(71) Applicant: Panasonic Intellectual Property Management Co., Ltd., Osaka (JP)

(72) Inventors: TATSUYA URAKAWA, Fukui (JP); DAISUKE SUETSUGU, Osaka (JP); NORIMICHI NOGUCHI, Osaka (JP)

(21) Appl. No.: 19/484,120

(22) PCT Filed: Jun. 14, 2024
(86) PCT No.: PCT/JP2024/021681

§ 371 Date: Nov. 13, 2025

(30) Foreign Application Priority Data
Jun. 30, 2023 (JP) 2023-108787

(51) Int. Cl. C04B 41/50; C04B 41/00; C04B 41/45; H01C 1/012; H01C 1/14

(52) U.S. Cl. CPC C04B 41/5031; C04B 41/0072; C04B 41/009; C04B 41/4539; C04B 41/4545; C04B 41/4572; H01C 1/012; H01C 1/14

(57) ABSTRACT

A ceramic substrate includes: a base substrate including a sintered body of ceramic particles; and a coating including a sintered body of α-alumina particles. The coating covers at least a part of a surface of the base substrate. An average particle size of the α-alumina particles is smaller than an average particle size of the ceramic particles.

### TECHNICAL FIELD

The present disclosure relates to a ceramic substrate and a method for manufacturing the ceramic substrate. More particularly, the present disclosure relates to a ceramic substrate including a base substrate including a sintered body of ceramic particles and a method for manufacturing the ceramic substrate.

### BACKGROUND ART

PTL 1 discloses a technique that includes preparing an alumina substrate containing silica glass, forming a glass coating over the entire surface of the alumina substrate, and forming an upper electrode and a resistive element on the glass coating.

### CITATION LIST

### Patent Literature

PTL 1: Japanese Patent Laid-Open Publication No. 2017-168749

### SUMMARY OF INVENTION

A ceramic substrate in accordance with an aspect of the present disclosure includes: a base substrate including a sintered body of ceramic particles (A); and a coating including a sintered body of α-alumina particles (B). The coating covers at least a part of a surface of the base substrate. An average particle size of the α-alumina particles (B) is smaller than an average particle size of the ceramic particles (A).

A method for manufacturing a ceramic substrate in accordance with an aspect of the present disclosure is a method for manufacturing the above-described ceramic substrate, and comprises: disposing the α-alumina particles (B) on the surface of the base substrate; and firing the α-alumina particles (B).

According to the present disclosure, a ceramic substrate with a high thermal conductivity and a high surface smoothness is provided.

### BRIEF DESCRIPTION OF DRAWINGS

FIG. 1 shows a microscope photograph of a section of a ceramic substrate according to an exemplary embodiment of the present disclosure.

FIG. 2 shows a microscope photograph of a section of a ceramic substrate according to the embodiment of the present disclosure.

FIG. 3 shows a microscope photograph of a surface of a ceramic substrate according to the embodiment of the present disclosure.

FIG. 4 is a schematic sectional view of an electronic device according to the embodiment of the present disclosure.

FIG. 5 is a schematic sectional view of a ceramic substrate according to the embodiment of the present disclosure.

FIG. 6 shows evaluation results of ceramic substrates according to the embodiment of the present disclosure.

### DESCRIPTION OF EMBODIMENT

### Exemplary Embodiment

An exemplary embodiment of the present disclosure will be described with reference to the accompanying drawings. It should be noted, however, that the exemplary embodiment described hereinafter are merely a part of various exemplary embodiments of the present disclosure. Also, the exemplary embodiment described hereinafter may be changed variously depending on designs or the like. It should be noted that the drawings referred to in the following description are schematic. Accordingly, the dimensional ratios of each structural element do not necessarily reflect actual dimensional ratios. It should be noted that the mechanisms of actions described in the following description are assumed mechanisms. Accordingly, the present disclosure should not be restricted by the mechanisms of actions described in the following description.

### Overview

A ceramic substrate 1 includes: a base substrate 2 including a sintered body of ceramic particles (A); and a coating 3 including a sintered body of α-alumina (Al₂O₃) particles (B). The coating 3 covers at least a part of a surface of the base substrate 2. An average particle size of the α-alumina particles (B) is smaller than an average particle size of the ceramic particles (A). This configuration provides the ceramic substrate 1 with a high thermal conductivity and a high surface smoothness.

Although the reason why the ceramic substrate 1 exhibits the above-mentioned properties is not accurately elucidated, the following reasons may be considered.

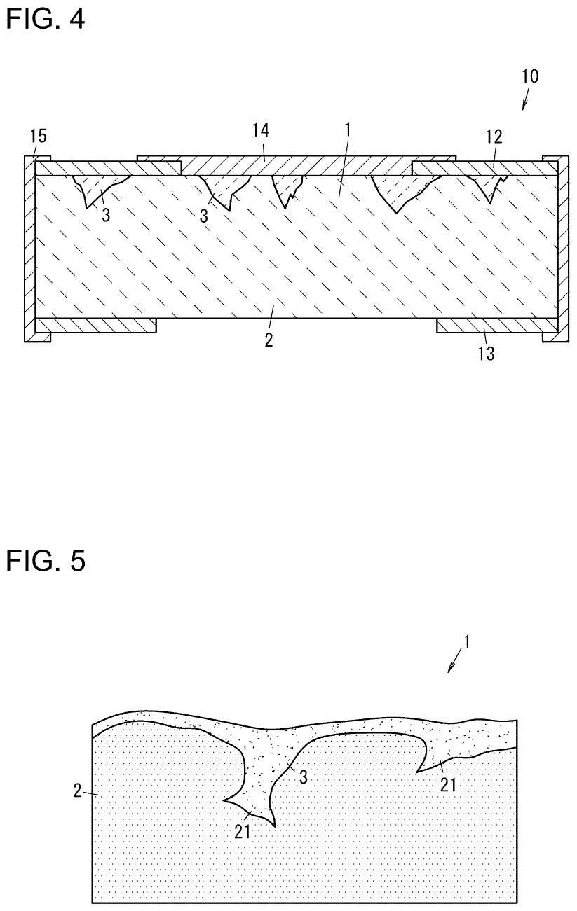

A base substrate 2 as shown in FIG. 4 which is used to produce an electronic device 10 including a resistive element 14 and electrodes 12 may not necessarily have an adequate smoothness when observed microscopically. Therefore, an electrostatic discharge (ESD) may be generated in the electronic device 10 including the base substrate 2. In order to enhance the surface smoothness of the base substrate 2, a film having a large smoothness may be formed on the surface of the base substrate 2. However, depending on a material of the film and properties thereof, the thermal conductivity of the base substrate 2 per se may be impaired or the film with a large smoothness may be hardly formed.

According to the present disclosure, regarding the above-described matters, at least a part of the surface of the base substrate 2 is covered with the coating 3 including a sintered body of α-alumina particles (B), each of which has a particular crystalline structure among the alumina particles that can provide the high thermal conductivity. Further, the coating 3 is adjusted such that the average particle size of the α-alumina particles (B) is smaller than the average particle size of the ceramic particles (A). This configuration increases the thermal conductivity and enhances the surface smoothness.

The sintered body of the α-alumina particles (B) may be produced by sintering the α-alumina particles (B). Upon being sintered, the α-alumina hardly has a volume shrinkage, and hardly causes irregularities on a surface of the coating 3 including the sintered body of the α-alumina particles (B), hence enhancing the smoothness of the ceramic substrate 1.

As described above, the ceramic substrate 1 has a high thermal conductivity and a high surface smoothness. Therefore, the electronic device 10 including the ceramic substrate 1 has both a high thermal conductivity and a high ESD immunity. In other words, the ceramic substrate 1 provides the electronic device 10 with a high thermal conductivity and a high ESD immunity.

In more detail, the electronic device 10 includes a ceramic substrate 1 with a large thermal conductivity. Therefore, heat generated at the resistive element 14 or the electrodes 14 is smoothly transferred to the ceramic substrate 1. Further, the electronic device 10 includes the ceramic substrate 1 with a large surface smoothness. Therefore, the resistive element 14 and the electrodes 12 formed on the ceramic substrate may be easily shaped, so that the resistive element 14 and the electrodes 12 may be formed without any local discontinuity or with less variations in their thickness. This configuration hardly causes destruction (disconnection) of the resistive element 14 and the electrodes 12, resultantly suppressing electrostatic discharge (ESD) in the electronic device 10. In other words, the electronic device 10 according to the embodiment can have a high ESD immunity.

In the following description, the term “average particle size” of the particles means a value of D50 obtained from a particle size distribution. Also, the term “maximum particle size” of the particles means a value of D90 obtained from the particle size distribution. The particle size distribution may be measured in various methods. An example of the particle size distribution is a distribution on a volume basis measured by a laser diffraction and scattering method.

### Ceramic Substrate

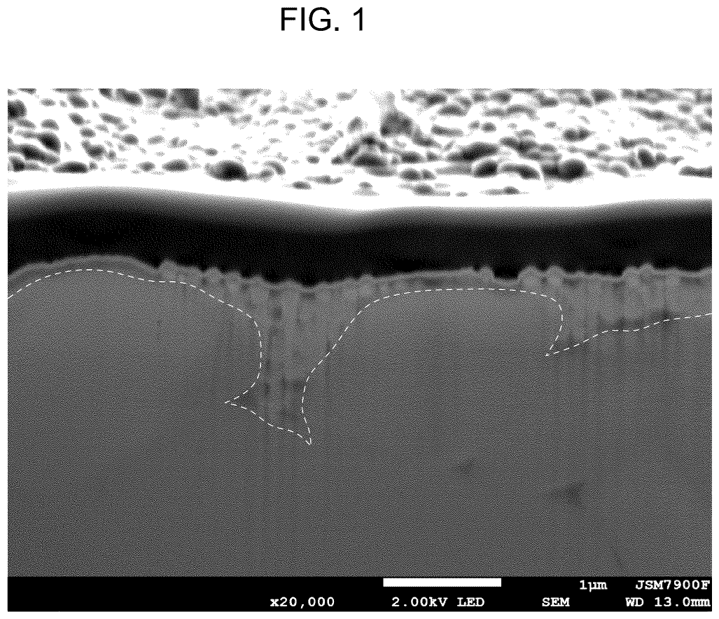

The ceramic substrate 1 will be described below. FIG. 1 shows a microscope photograph of a part of the ceramic substrate 1 captured with a microscope. FIG. 5 is a schematic sectional view of the ceramic substrate 1 based on the microscope photograph of the ceramic substrate 1 shown in FIG. 1.

### Base Substrate

The ceramic substrate 1 includes a base substrate 2. The base substrate 2 has, e.g., a rectangular shape in the plan view (viewed in a thickness direction of the base substrate 2).

The base substrate 2 includes a sintered body of ceramic particles (A). The average particle size of the ceramic particles (B) may not particularly be limited, but may, for example, range from 0.5 μm to 8 μm. The average particle size of the ceramic particles (A) may be preferably about 3 μm. This size may increase the thermal conductivity of the ceramic substrate 1 and enhance the surface smoothness of the ceramic substrate 1. The ceramic particles (A) may include particles each having a diameter of about 10 μm.

In accordance with the embodiment, the ceramic particles (A) include alumina particles (A1). In other words, the base substrate 2 includes a sintered body of the alumina particles (A1). That is, the base substrate 2 is a sintered alumina substrate. In this configuration, the base substrate 2 has a high thermal conductivity. This increases the thermal conductivity of the ceramic substrate 1.

The content percentage of the alumina particles (A1) in the entire ceramic particles (A) may be preferably equal to or larger than 96 mass %. In other words, the content percentage of the sintered body of the alumina particles (A1) in the entire base substrate 2 may be preferably equal to or larger than 96 mass %. This configuration adequately increases the thermal conductivity of the ceramic substrate 1. The upper limit of the content percentage of the alumina particles (A1) in the ceramic particles (A) may be, for example, 100 mass %.

The crystalline structure of the alumina particle (A1) contained in the ceramic particles (A) may not be particularly limited, but may preferably be an a type. In other words, the ceramic particles (A) may preferably include α-alumina particles (A11). This configuration increases the thermal conductivity of the ceramic substrate 1.

The surface roughness of the base substrate 2 may range, for example, from several nanometers to several thousand nanometers. The surface roughness may be the maximum height roughness (Rs) measured with an atomic force microscope (AFM). The surface roughness (the maximum height roughness) of the base substrate 2 may be about 2500 nm.

As described above, the base substrate 2 for producing the ceramic substrate 1 may have an inadequate smoothness when observed microscopically. In more detail, a recess 21 may be produced for at least one of such reasons: that the shapes of the ceramic particles (A) used as the raw material of the base substrate 2 appear on the surface of the base substrate 2 during producing the base substrate 2; that the ceramic particles (A) move or deform due to the grain growth associated with the sintering of the ceramic particles (A); and that binder used for producing the base substrate 2 is disappeared during the sintering. The produced recess 21 reduces the smoothness of the base substrate 2. The shape of the recess 21 is not a particular shape, and may, for example, be a V-shape (see the right side in FIG. 5). The recess 21 may have a complicated shape deep inside the recess (see the left side in FIG. 5).

### Coating

The ceramic substrate 1 includes a coating 3.

As described above, the recess 21 may be produced in the base substrate 2, and the recess 21 may reduce the surface smoothness of the base substrate 2. The coating 3 covers the recess 21 produced in the base substrate 2, thereby enhancing the surface smoothness of the ceramic substrate 1. As a result, the ceramic substrate 1 is provided with the ESD immunity. The maximum height roughness (Rs) of the part of the ceramic substrate 1 on which the coating 3 is formed may range, for example, from 30 nm to 1000 nm.

Plural recesses 21 may be produced in the surface of the base substrate 2. In this case, the coating 3 preferably covers at least one of the plural recesses 21 produced in the surface of the base substrate 2. This configuration enhances the surface smoothness of the ceramic substrate 1. As a result, the ceramic substrate 1 is provided with a large ESD immunity. In addition, the coatings 3 preferably cover as many recesses 21 as possible among the plural recesses 21 produced in the surface of the base substrate 2. As the number of recesses 21 covered with the coatings 3 increases, the surface smoothness of the ceramic substrate 1 is more enhanced. As a result, the ceramic substrate 1 is provided with a large ESD immunity.

As described above, a recess 21 having a complicated shape deep inside may be produced in the surface of the base substrate 2 (see the left side in FIG. 5). In the case where the recess 21 having a complicated shape deep inside is produced in the base substrate 2, a coating with a film applied to enhance the surface smoothness of the base substrate 2 may not necessarily cover a space deep inside the recess 21. In other words, the film may not fully fill the space inside of the recess 21, so that an air gap may be produced. In the case where the base substrate 2 having the surface coated with a film has an air gap described above, the ESD immunity may not be adequately secured. On the other hand, according to the present disclosure, the coating 3 is adjusted such that the average particle size of the α-alumina particles (B) is smaller than the average particle size of the ceramic particles (A). This configuration allows the coating 3 to be formed in the recess 21 having a complicated shape deep inside so that the inside of the recess 21 may be adequately filled with the coating, thereby preventing the air gap from being easily produced between the coating 3 and the base substrate 2. As a result, the ceramic substrate 1 is provided with a high ESD immunity.

The maximum thickness of the coating 3 may be smaller than the surface roughness of the base substrate 2. In other words, the coating 3 may not cover the entire surface of the base substrate 2 and a part of the surface of the base substrate 2 with no recess 21 may be exposed on the surface of the ceramic substrate 1. This configuration allows the high thermal conductivity possessed by the base substrate 2 itself to be exerted, so that the thermal conductivity of the ceramic substrate 1 can be increased. In this case, the coating 3 may adequately fill the recess 21 produced in the base substrate 2 to adequately enhance the smoothness of the surface on which the coating 3 is formed. In other words, the coating 3 does not cover the entire surface of the base substrate 2 and the part of surface of the base substrate 2 on which any recess 21 does not formed is exposed on the surface of the ceramic substrate 1. The surface smoothness is adequately enhanced in the part on the surface of the ceramic substrate 1 in which the coating 3 is applied. This configuration increases the thermal conductivity of the ceramic substrate 1 as well as to particularly enhance the ESD immunity of the ceramic substrate 1. The maximum thickness of the coating 3 may preferably be equal to or smaller than 2500 nm.

The α-alumina particle (B) may preferably have a spherical shape. This configuration increases the thermal conductivity of the ceramic substrate 1 as well as enhancing the surface smoothness of the ceramic substrate 1. In accordance with the present disclosure, “spherical” means to include “roughly spherical” in addition to “true spherical.” The α-alumina particle (B) may have, for example, a polygonal shape, a tabular shape, a flaky shape, or an acicular shape.

As describe above, the coating 3 includes a sintered body of the α-alumina particles (B). The content percentage of the sintered body of the α-alumina particles (B) in the entire coating 3 may range preferably from 50 mass % to 100 mass %. This range increases the thermal conductivity of the ceramic substrate 1 as well as enhancing the surface smoothness of the ceramic substrate 1. The content percentage of the sintered body of the α-alumina particles (B) may more preferably be equal to or larger than 80 mass %, and still more preferably be equal to or larger than 95 mass %. The content percentage of the sintered body of the α-alumina particles (B) in the entire coating 3 may be 100 mass %.

As describe above, the coating 3 includes a sintered body of the α-alumina particles (B). In other words, the raw material for producing the coating 3 contains the α-alumina particles (B). The ratio of the α-alumina particles (B) to the entire raw material for producing the coating 3 may preferably be equal to or larger than 50 mass %. More preferably, the ratio of the α-alumina particles (B) to the entire raw material for producing the coating 3 may be equal to or larger than 80 mass %. Still more preferably, the ratio of the α-alumina particles (B) to the entire raw material for producing the coating 3 may be equal to or larger than 95 mass %. The raw material for producing the coating 3 may contain β-alumina particles or γ-alumina particles. The ratio of the β-alumina particles or the γ-alumina particles to the entire raw material for producing the coating 3 may preferably be equal to or smaller than 50 mass %. This configuration enhances the smoothness of the ceramic substrate 1. The reason for this may be considered that, although the β-alumina particles or the γ-alumina particles may cause the coating 3 to deform due to the phase change during firing, the β-alumina particles or the γ-alumina particles with the range equal to or smaller than 50 mass % suppresses the deformation of the coating 3.

The average particle size of the α-alumina particles (B) may range preferably from 30 nm to 1000 nm. This configuration increases the thermal conductivity of the ceramic substrate 1 as well as enhancing the surface smoothness of the ceramic substrate 1. The average particle size of the α-alumina particles (B) may more preferably be equal to or larger than 50 nm, and still more preferably be equal to or larger than 100 nm. The average particle size of the α-alumina particles (B) may more preferably be equal to or smaller than 900 nm, and still more preferably be equal to or smaller than 500 nm. In addition, the ratio of the average particle size of the α-alumina particles (B) to the average particle size of the ceramic particles (A) may preferably be equal to or smaller than ⅓. This configuration more increases the thermal conductivity of the ceramic substrate 1 as well as more enhancing the surface smoothness of the ceramic substrate 1. The ratio of the average particle size of the α-alumina particles (B) to the average particle size of the ceramic particles (A) may more preferably be equal to or smaller than ⅙, and still more preferably be equal to or smaller than 1/20.

The maximum particle size of the α-alumina particles (B) may preferably be equal to or smaller than 1500 nm. This condition increases the thermal conductivity of the ceramic substrate 1 as well as enhancing the surface smoothness of the ceramic substrate 1. The maximum particle size of the α-alumina particles (B) may more preferably be equal to or smaller than 1000 nm, and still more preferably be equal to or smaller than 500 nm.

The α-alumina particles (B) may be a commercially available product. Commercially available products of α-alumina particles (B) include, for example, AKP-50 (made by Sumitomo Chemical Co., Ltd.), MXA-150B (made by Sumitomo Chemical Co., Ltd.), TM-DA (made by Taimei Chemicals Co., Ltd.), TM-DAR (made by Taimei Chemicals Co., Ltd.), and 642991 (made by Sigma-Aldrich Co. LLC). One of these commercially available products may be used alone or two or more of the commercially available products may be used in combination.

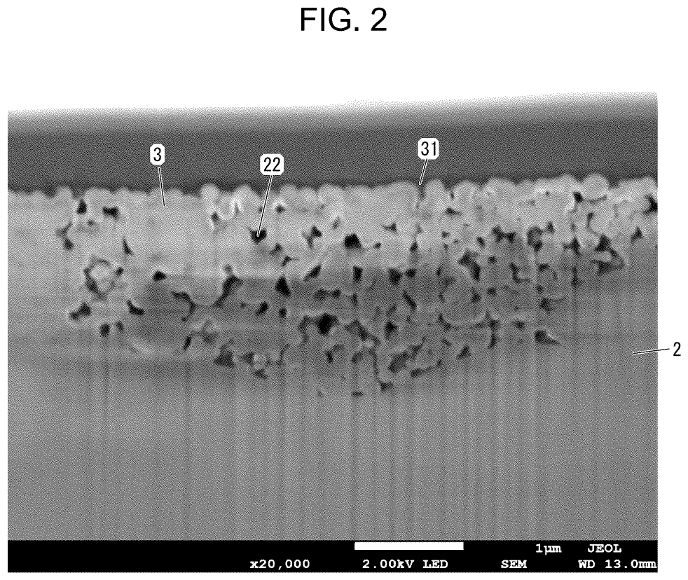

The coating 3 may have pores 22 therein (see FIG. 2). In other words, the sintered body of the α-alumina particles (B) contained in the coating 3 may have has pores 22 therein. The ratio of the pores 22 in the coating 3 may be appropriately adjusted to appropriately adjust the density of the coating 3. This adjustment adequately secures the thermal conductivity of the ceramic substrate 1 as well as ensuring such a function of the coating 3 that alleviates stress generated in the ceramic substrate 1. The term “density” used in the present disclosure means an apparent density. In addition, the density of the coating 3 is preferably smaller than the density of the base substrate 2. In this case, the ratio of the pores 22 to the coating 3 may be appropriately adjusted so that the density of the coating 3 may become smaller than the density of the base substrate 2. Therefore, the coating 3 may have an appropriate flexibility. In this configuration, even in a case where a stress is generated in the ceramic substrate 1, the stress is particularly alleviated by the coating 3. The density of the coating 3 may preferably be equal to or lower than 0.9 times the density of the base substrate 2, more preferably be equal to or lower than 0.8 times the density of the base substrate 2, and still more preferably be equal to or lower than 0.7 times the density of the base substrate 2.

The coating 3 may include, in addition to the sintered body of the α-alumina particles (B), a sintered body of an inorganic material other than the α-alumina particles (B) (hereinafter referred to as the inorganic material (C)). This configuration facilitates or suppresses generation of the pores 22 in the coating 3 so as to resultantly adjust the density of the coating 3. The inorganic material (C) may be at least one selected from the group consisting of, for example, boehmite (AlOOH), zirconia (ZrO₂), silica (SiO₂), magnesia (MgO), calcia (CaO), and aluminum nitride (AlN). Among these, the inorganic material (C) may preferably contain boehmite. In this case, boehmite increases the sinterability of the α-alumina particles, and prevents the ratio of the pores 22 in the coating 3 from excessively increasing, thereby reducing the density of the coating 3 appropriately. As a result, the large thermal conductivity of the ceramic substrate 1 can be maintained.

Boehmite may include pseudo-boehmite. The pseudo-boehmite may be used as a colloid (an alumina sol) in which nano-particles of pseudo-boehmite are dispersed in a solvent.

The shape of boehmite may not particularly be limited, but may preferably be granular. This condition allows the boehmite particles to easily intervene between the α-alumina particles (B), thereby increasing the sinterability of the α-alumina particles (B). This configuration appropriately increases the ratio of the pores to the sintered body in the coating 3. As a result, the increased thermal conductivity of the ceramic substrate 1 is more securely maintained.

Boehmite may be a commercially available product. The commercially available boehmite products include, for example, 10A (made by Kawaken Fine Chemicals Co., Ltd.), AS-520A (made by Nissan Chemical Corporation), AS-2 (made by Kawaken Fine Chemicals Co., Ltd.), and AS-200 (made by Nissan Chemical Corporation).

Cracks 31 may be produced in the coating 3 (see FIG. 2). The number of cracks 31 in the coating 3 may not particularly be limited, but may preferably be small. This condition adequately secures the surface smoothness of the ceramic substrate 1. The maximum height roughness (Rz) in the area of the ceramic substrate 1 having the coating 3 formed thereon is measured by selecting parts at which any cracks 31 are not produced.

For example, the crack 31 may develop to extend from the outer surface of the coating 3 (the surface of the coating 3 opposite to the surface of the coating 3 facing the base member 2) in the thickness direction of the base substrate 2. The depth of the crack 31 in the thickness direction of the base substrate 2 may preferably be smaller than the maximum length of the α-alumina particles (B). This condition may adequately secure the surface smoothness of the ceramic substrate 1, and resultantly provides the ceramic substrate 1 with the ESD immunity adequately. Specifically, the depth of the crack 31 may preferably be equal to or smaller than 100 nm, more preferably be equal to or smaller than 50 nm, and still more preferably be equal to or smaller than 30 nm. The maximum length of the α-alumina particles (B) referred to here may be D90 in the grain distribution measurement in the case where each α-alumina particle (B) has substantially a spherical shape. In the case where the shape of the particle has a major axis and a minor axis which are different from each other, the maximum length of the α-alumina particle (B) may be confirmed by measuring the outline of the particle in a photographed image. The coating 3 preferably has no crack 31 therein. This condition adequately secures the surface smoothness of the ceramic substrate 1, accordingly providing the ceramic substrate 1 with the ESD immunity.

As described above, the coating 3 including a sintered body of the α-lumina particles (B) covers at least a part of the surface of the base substrate 2 including a sintered body of the ceramic particles (A). This configuration enhances the surface smoothness of the ceramic substrate 1. The structure of the coating 3 may not particularly be limited as far as the coating 3 enhances the surface smoothness of the ceramic substrate 1. For example, the coating 3 may have a continuous planar shape. The coating 3 may have a discontinuous planar shape. However, the coating 3 may preferably have a continuous planar shape. This structure more enhances the surface smoothness of the ceramic substrate 1, hence providing the ceramic substrate 1 with a high ESD immunity.

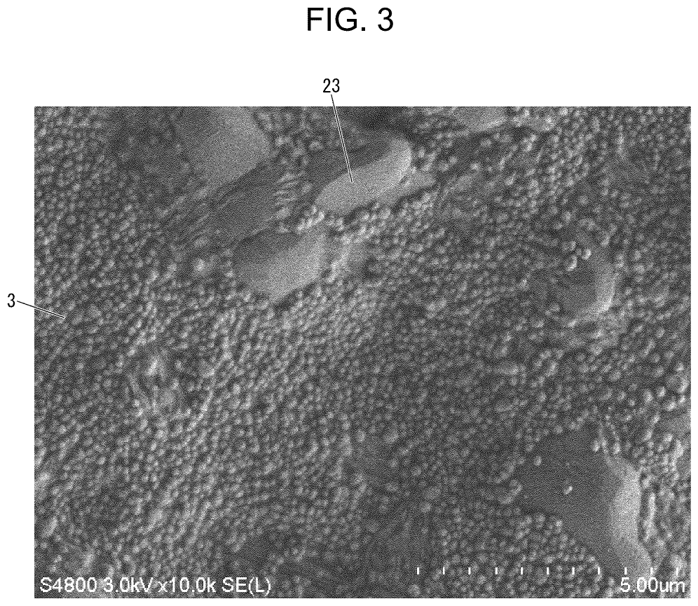

The surface of the base substrate 2 may preferably have a part that is not covered with the coating 3 (hereinafter called an uncovered part 23) (see FIG. 3). In other words, the maximum height roughness (Rz) of the ceramic substrate 1 at the part thereof covered with the coating 3 is adjusted so as to be smaller than the maximum height roughness (Rz) of the base substrate 2 by covering the recesses 21 with the coating 3 while leaving the uncovered part 23 at the part at which the recesses 21 are not produced on the ceramic substrate 1. This configuration increases a high thermal conductivity possessed by the base substrate 2 itself. Accordingly, the thermal conductivity of the ceramic substrate 1 can be more increased. The uncovered part 23 means the part of the surface of the base substrate 2 which is not covered with the coating 32 out of the surface of the base substrate 2 on which the coating 3 is provided.

The ratio of the area of the uncovered part 23 to the entire surface of the base substrate 2 on which the coating 3 is provided may preferably range from 5% to 70%. In the range of the ratio of the area equal to or larger than 5%, the thermal conductivity of the ceramic substrate 1 can be more increased. In the range of the ratio of the area equal to or smaller than 70%, the surface smoothness of the ceramic substrate 1 can be adequately secured.

### Method for Manufacturing Ceramic Substrate

A method for manufacturing the ceramic substrate 1 will be described below.

The ceramic substrate 1 may be produced by disposing the α-alumina particles (B) on a surface of the base substrate 2, and firing the disposed α-alumina particles (B). The coating 3 thus contains the α-alumina particles (B) fired on the surface of the base substrate 2. The method in accordance with the embodiment is a method for manufacturing a ceramic substrate 1 by applying a coating liquid containing α-alumina particles (B) (hereinafter referred to as coating liquid (X)) onto a surface of the base substrate 2, drying the applied coating liquid (X), and then, firing the applied coating liquid (X).

### Coating Liquid

The coating liquid (X) will be described below. As described above, the coating liquid (X) contains the α-alumina particles (B). The coating 3 may further include a sintered body of the inorganic material (C). In other words, the coating liquid (X) may contain the inorganic material (C) in addition to the α-alumina particles (B).

As described above, the inorganic material (C) may contain boehmite. In other words, the coating liquid (X) may contain boehmite in addition to the α-alumina particles (B). The ratio of the content of the α-alumina particles (B) to the boehmite in percentage by mass may preferably range from 100:0 to 80:20. This condition appropriately increases the sinterability of the α-alumina particles (B) as well as suppressing excessive contraction of the coating 3 which is likely to be caused by the sintering of boehmite, hence preventing an occurrence of a breakage or the crack 31 in the coating 3. The percentage by mass may more preferably range from 95:5 to 67:33.

The coating liquid (X) may contain a dispersant. This configuration increases the dispersibility of the α-alumina particles (X) contained in the coating liquid (X). Accordingly, when the coating liquid (X) is applied to the base substrate 2, the α-alumina particles (B) spread uniformly over the entire surface of the base substrate 2. As a result, the surface smoothness of the base substrate 2 is enhanced. The dispersant may further contain, for example, at least one selected from the group consisting of, for example, an acrylic acid polymer and a carboxylic acid polymer. The dispersant may preferably contain an acrylic acid polymer. This configuration enhances the dispersibility of the α-alumina particles (B). Further, the dispersant may be a commercially available product. Commercially available dispersant products include, for example, SD-10 (made by Toagosei Co., Ltd.), A-30SL (made by Toagosei Co., Ltd.) and A6114 (made by Toagosei Co., Ltd.). The method of increasing the dispersibility of the α-alumina particles (B) in the coating liquid (X) may not be limited to the use of the dispersant. For example, the pH value of the coating liquid (X) may be adjusted to increase the dispersibility of the α-alumina particles (B) in the coating liquid (X). The method of adjusting the pH value of the coating liquid (X) may not particularly be limited, and may, for example, be a method using a chemical agent containing a nitric acid or ammonia. The chemical agent does not preferably contain an alkaline metal, such as Na, or a halogen element, such as Cl, or contains the alkaline metal and the halogen element within a limited amount so as not to adversely affect the actual electronic device 10. The range of the pH value of the coating liquid (X) may not particularly be limited, but may preferably be adjusted to range from 4 to 7.

The coating liquid (X) may contain a solvent to enhance the coatability of the coating liquid (X). The ratio of the solvent to the entire coating liquid (X) may preferably range from 20 mass % to 80 mass %. This range allows the α-alumina particles (B) to spread uniformly over the surface of the base substrate 2. This configuration prevents the coating 3 covering the surface of the base substrate 2 from ununiformly spreading to locally produce a part with a locally low density of the sintered body of the α-alumina particles (B) and a part with a locally high density of the sintered body of the α-alumina particles (B). As a result, the thermal conductivity of the ceramic substrate 1 is increased, the surface smoothness of the ceramic substrate 1 is enhanced, and the stress generated in the ceramic substrate 1 is alleviated. The solvent may be, for example, water or an organic solvent. The organic solvent may preferably be a low volatility solvent, specifically, for example, a terpineol.

As described above, the recess 21 may be produced in the surface of the base substrate 2 (see FIG. 5). The coating 3 may be formed in the recess 21 by applying the coating liquid (X) containing the α-alumina particles (X) to the base substrate 2 to fill the recess 21 with the coating liquid (X), and then firing the coating liquid (X). The coating 3 may thus be formed in the recess 21 to fill the recess 21, so that the surface smoothness of the ceramic substrate 1 obtained by coating the surface of the base substrate 2 with the coating 3 can be enhanced. The average particle size of the α-alumina particles (B) is adjusted so as to be smaller than the average particle size of the ceramic substrate (A). Therefore, even if the recess 21 is complicated deep inside, the α-alumina particles (A) adequately fill the recess 21. In this condition, upon being fired to form the coating 3 including a sintered body of the α-alumina particles (B), the coating liquid (X) prevents gaps from being produced between the base substrate 2 and the coating 3. As a result, the ceramic substrate 1 is provided with a high ESD immunity.

The particle size distribution of the α-alumina particles (B) may be appropriately adjusted so that the recess 21 produced in the base substrate 2 can be easily filled with the coating liquid (X). The particle size distribution of the α-alumina particles (B) may be adjusted by appropriately combining plural commercially available products which are different from one another in the particle size distribution.

### Method of Producing the Coating Liquid

A method of producing the coating liquid (X) may not particularly be limited, and may be the following method. First, materials containing the α-alumina particles (B) are kneaded with a kneading machine to obtain a mixture (M). Then, the mixture (M) is stirred with a stirring apparatus to disperse the α-alumina particles (B) in the mixture. Then, the mixture (M) after the dispersing is kneaded again with a kneading machine to obtain the coating liquid (X). The kneading with the kneading machine may preferably be performed while defoaming the mixture. In this method, bubbles generated in the coating liquid (X) are reduced. Accordingly, the base substrate 2 is uniformly coated with the coating liquid (X).

The kneading machine may not particularly be limited, and may be, for example, a planetary centrifugal mixer or a pot mill. The stirring apparatus may not particularly be limited, and may be, for example, an ultrasonic homogenizer, a bead mill, or a jet homogenizer.

### Method of Producing Ceramic Substrate Using Coating Liquid

A method of producing the ceramic substrate 1 using the coating liquid (X) may include: coating the surface of the base substrate 2 with the coating liquid (X) containing the α-alumina particles (B); and firing the coating liquid (X). The method of producing the ceramic substrate 1 using the coating liquid (X) may further include removing the solvent as needed. The method for manufacturing the ceramic substrate 1 will be detailed below.

First, the coating liquid (X) containing the α-alumina particles (B) is applied to the surface of the base substrate 2. The application method may be, for example, an application method using a squeegee, an application method using a bar coater, an application method using a spin coater, an application method by printing, or an application method by spraying. The application method by printing may be at least one selected from the group consisting of a gravure printing, a flexographic printing, an offset printing, a screen printing, and an inkjet printing.

Among the application methods listed above, the application method using a squeegee may preferably be used. Regarding the application method using a squeegee, the following method was actually performed. First, the coating liquid (X) was put on the base substrate 2. Then, an excess part of the coating liquid (X) was scraped off with a squeegee pushed with a downward force to coat the surface of the base substrate 2 with the coating liquid (X). The application method using the squeegee allows the coating liquid (X) to be applied while appropriately suppressing uneven coating on the surface of the base substrate. Accordingly, the surface smoothness of the ceramic substrate 1 is enhanced. As a result, the ceramic substrate 1 is provided with a high ESD immunity. The application method using the squeegee allows the recess 21 in the surface of the base substrate 2 to be efficiently filled with the coating liquid (X), thereby preventing gaps from being caused between the formed coating 3 and the base substrate 2. Accordingly, the thermal conductivity of the ceramic substrate 1 is increased. Further, the application method using the squeegee easily forms a part of the surface of the base substrate 2 to which the coating liquid (X) does not adhere to. Accordingly, the part at which the surface of the base substrate 2 is not covered with the coating 3 (the uncovered part 23) is thus not formed. This configuration produces the high thermal conductivity possessed by the base substrate 2 itself. As a result, the thermal conductivity of the ceramic substrate 1 is increased.

Next, the solvent is removed from the applied coating liquid (X). Specifically, the base substrate 2 coated with the coating liquid (X) is placed in a drying furnace, and dried to remove the solvent. The heating may preferably be conducted such that the solvent may be efficiently removed and a sudden boiling of the solvent is not caused. Specifically, the heating temperature may range, for example, from 80 °C to 150 °C. The heating time may range, for example, from 0.5 hours to 2 hours. The heating may be conducted under atmospheric conditions.

Next, the coating liquid (X) from which the solvent has been removed is fired. The base substrate 2 having been coated with the coating liquid (X) is placed in an electric furnace and fired in the electric furnace. The firing temperature may range, for example, from 1100 °C to 1600 °C. Firing at a temperature equal to or higher than 1100 °C allows the α-alumina particles (B) to be sintered slowly. Therefore, it is possible to adjust the densification of the sintered body of the α-alumina particles (B) contained in the coating 3. Accordingly, the shape of the coating 3 is maintained, so that the surface smoothness of the ceramic substrate 1 may be enhanced. Firing at a temperature equal to or higher than 1300 °C allows the α-alumina particles (B) to be sintered at an appropriate rate. This configuration reduces the ratio of the pores 22 in the sintered body of the α-alumina particles (B) contained in the coating 3. As a result, the thermal conductivity of the ceramic substrate 1 is increased. Firing at a temperature equal to or lower than 1600 °C prevents the α-alumina particles (B) from being excessively sintered. This configuration hardly causes unevenness on the coating 3, and enhances the surface smoothness of the ceramic substrate 1. As a result, the ceramic substrate 1 is provided with a high ESD immunity.

The firing time may not particularly be limited, and may range, for example, from 1 hour to 12 hours. This range adequately increases the thermal conductivity of the ceramic substrate 1 as well as adequately enhancing the surface smoothness of the ceramic substrate 1.

Depending on components contained in the coating liquid (X), a preliminary firing may be conducted before starting the firing (the final firing).

The temperature profile may appropriately be determined such that a step including raising the temperature and firing at a constant temperature is repeated to change the temperature step by step during firing.

A method for manufacturing the ceramic substrate 1 was described above, however, the method for manufacturing the ceramic substrate 1 may not be limited to the above-described method, and may be any other appropriate method.

### Application Example

As described above, the ceramic substrate 1 may be applied to the electronic device 10 (see FIG. 4). The ceramic substrate 1 has a high thermal conductivity. Therefore, the electronic device 10 including the ceramic substrate 1 has a high thermal conductivity.

The ceramic substrate 1 has a high surface smoothness. Therefore, the ceramic substrate 1 provides a high ESD immunity. As a result, the electronic device 10 including the ceramic substrate 1 has a high ESD immunity.

Specific examples of the electronic device 10 include a chip resistor, a thermistor, and a resistance temperature detector.

### Configuration of the Electronic Device

A specific configuration of the electronic device 10 will be described below. The electronic device 10 includes a resistive element 14 and a pair of electrodes 12 (upper electrodes). The pair of electrodes 12 are disposed on both ends of a surface (a front surface) of the ceramic substrate 1 having the coating 3 disposed thereon, respectively. The electrodes 12 may directly contact the surface of the base substrate 2 or contact the coating 3. Each of the electrodes 12 may, e.g., contain copper. The electrodes may be formed on the surface of the ceramic substrate 1 by, for example, sputtering.

The resistive element 14 is disposed on the surface (a front surface) of the ceramic substrate 1 on which the coating 3 is formed. Accordingly, the electrodes 12 may directly contact the surface of the base substrate 2 or contact the coating 3. The resistive element 14 is disposed between the pair of electrodes 12 and connected to the pair of electrodes 12. The resistive element 14 may be covered with a protective layer. The protective layer may contain, for example, an epoxy resin. The resistive element 14 may contain, for example, a metal alloy. The metal may be at least one selected from the group consisting of, for example, nickel (Ni), chrome (Cr), aluminum (Al), platinum (Pt), and silicon (Si). The method of forming the resistive element 14 on the surface of the ceramic substrate 1 may not particularly be limited, but may be a method of pattern forming a thin film made of metal alloy on the surface of the ceramic substrate 1. Specifically, a thin film containing the metal alloy is formed on the surface of the ceramic substrate 1. The method of forming the thin film may not particularly be limited, and may be, for example, sputtering. Then, the thin film is patterned by photolithography to produce the resistive element 14 from the thin film. The photolithography process includes steps of, for example, of applying a photoresist to the ceramic substrate, drying the applied photoresist, exposing the photoresist to light, etching the thin film to remove unnecessary parts, and stripping the photoresist. The resistive element 14 may be disposed on the surface of the ceramic substrate 1 in the above-described method.

The electronic device 10 may further include a pair of electrodes 13 (lower electrodes). The pair of electrodes 13 may be disposed on both ends of a surface (a back surface) of the ceramic substrate 1 opposite to the surface of the ceramic substrate 1 on which the coating 3 is formed. The electronic device 10 may further include a pair of end electrodes 15. For example, the pair of end electrodes 15 may be formed on both end surfaces of the ceramic substrate 1, respectively, so as to be electrically connected to the pair of electrodes 12, respectively.

### Properties of Electronic Device

As described above, the electronic device 10 according to the embodiment has a high ESD immunity. Specifically, it is possible to increase the values of the ESD breakdown voltage and the ESD breakdown current density at the resistive element 14 of the electronic device 10. The values of the ESD breakdown voltage and the ESD breakdown current density of the electronic device 10 may be measured according to the electrostatic discharge immunity test (AEC-Q200).

### EXAMPLES

The present disclosure will be described below more specifically using some examples. It should be noted that the present disclosure is not limited by the following working examples. The examples may be appropriately modified for implementation, and each of those modifications is included within a technical scope of the present disclosure.

In the Examples, production of samples of the coating liquid (X) for producing the coatings 3, production of the ceramic substrates 1, production of the electronic devices 10 having the respective ceramic substrates 1, and an evaluation result of the produced electronic devices 10 will be described below.

### Production of Samples of Coating Liquid

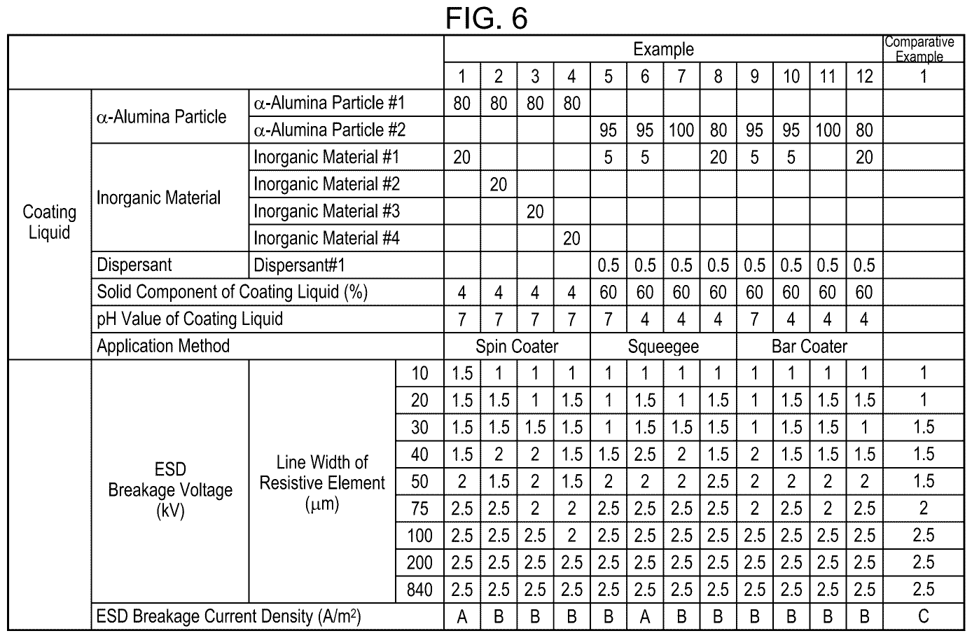

First, coating liquid (X) for producing the coating 3 was produced for each example. Specifically, the coating liquid was produced as follows. First, materials having the respective composition ratios as shown in FIG. 6 were put in a container for kneading. Then, the container for kneading was set in a planetary centrifugal mixer (product name: RE-310 made by THINKY CORPORATION), and the materials were kneaded while being defoamed to produce a mixture (M). Then, materials including α-alumina particles were dispersed in the mixture (M) with an ultrasonic homogenizer (product name: UX-600 made by Mitsui Electric Co., Ltd.). Then, the mixture (M) was defoamed with the planetary centrifugal mixer to produce coating liquid (X). Aqueous solution having a pH value adjusted by nitric acid was added to the coating liquid (X) so that the concentration of its solid content (the α-alumina and the inorganic material) became the value shown in FIG. 6 and the pH value of the coating liquid (X) became the value shown in FIG. 6.

The materials used to produce the coating liquid (X) will be detailed below:
α-alumina particles #1: TM-DAR (made by Taimei Chemicals Co., Ltd.), approximately spherical (the particle shape), an average particle size of 0.16 μm, and a maximum particle size of 0.35 μm.
α-alumina particles #2: NXA-150 (made by Sumitomo Chemical Co., Ltd.), spherical (particle shape), an average particle size of 0.18 μm, and a maximum particle size of 1 μm.
inorganic material #1: 10A (made by Kawaken Fine Chemicals Co., Ltd.), an alumina sol, granular, an average particle size of 10 to 15 nm, and 10 mass % Al₂O₃.
inorganic material #2: AS-520A (made by Nissan Chemical Corporation), an alumina sol, granular, an average particle size of 15 nm, and 20.5 mass % Al₂O₃.
inorganic material #3: AS-2 (made by JGC Catalysts and Chemicals Ltd.), an alumina sol, tabular (particle shape), a secondary particle diameter of 170 to 200 nm, and 10.5 mass % Al₂O₃.
inorganic material #4: AS-200 (made by Nissan Chemical Corporation), an alumina sol, feather particles, an average particle size of 10 to 100 nm, and 10.5 mass % Al₂O₃.
dispersant #1: SD-10 (made by Toagosei Co., Ltd.), a dispersant containing an acrylic acid polymer.

The inorganic materials #1 to #4 include alumina sol, and the solid content of the sol is calculated as a value in terms of Al₂O₃, and the value is shown in FIG. 6.

### Production of the Ceramic Substrates

Ceramic substrates 1 were produced using the samples of the coating liquid (X) produced in the above-described method. Specifically, each ceramic substrate 1 was produced in the following method.

First, the coating liquid (X) was applied to the base substrate 2 (a sintered alumina substrate produced from alumina particles having an average particle size of 3 μm (an alumina content rate of 96 mass %)) in the application method shown in FIG. 6.

Then, the base substrate coated with the coating liquid (X) was put in a drying machine, and a drying step was conducted to dry the solvent. The drying step was conducted at 80 °C for 3 hours under atmospheric conditions. Then, the base substrate 2 coated with the coating liquid (X) was fired in an electric furnace. The firing was conducted at 1280 °C for 3 hours under atmospheric conditions. In this way, a ceramic substrate 1 having a surface of the base substrate 2 covered with the coating 3 were produced.

The application method using a squeegee was conducted using screen printing equipment which had been modified so that the squeegee contacted the base substrate 2 without using the screen while the material was supplied by dropping a specified amount of material. Regarding the application method using the squeegee, it was able to be confirmed that the uncovered part 23 was formed on the ceramic substrate 1.

The application method using a spin coater was conducted using a spin coater (made by Mikasa Co., Ltd.) in the condition at a rotation speed of 1500 rpm for 30 minutes.

The application method using a bar coater was conducted using a bar coater (product name: A-BAR made by OSG System Products Co., Ltd.) and adjusting the distance between the base substrate 2 and the bar coater so that the wet film thickness became 2 μm.

The maximum height roughness (Rz) of the base substrate 2 was 2473 nm. The maximum height roughness (Rz) was measured with an atomic force microscope (made by Hitachi High-Tech Science Corporation).

The microscope photograph shown in FIG. 1 was obtained by observing a section of a ceramic substrate 1 produced in Example 6 with a scanning electron microscope (SEM). The microscope photograph shown in FIG. 2 was obtained by observing a section of the ceramic substrate 1 produced in Example 10 with the scanning electron microscope (SEM). The microscope photograph shown in FIG. 3 was obtained by observing a surface of the ceramic substrate 1 produced in Example 6 with the scanning electron microscope (SEM).

### Method of Producing Electronic Devices

A resistive element 14 was produced on the surface of the ceramic substrate 1 on which the coating 3 has been disposed. In detail, a thin film of an NiCrAlSi alloy was formed by sputtering, and the thin film was patterned to a line shape with a width ranging from 10 to 840 μm by photolithography (resist application, drying, exposure, development, etching, and resist stripping) to form the resistive element 14. Electrodes 12 were formed on both ends of the line-shape resistive element 14, respectively, to obtain an electronic device 10. The distance between the electrodes was 1.1 mm.

Comparative samples of electronic device 10 were produced using the base substrate 2 used in Examples 1 to 12 (the sintered alumina substrate in which the content rate of alumina was 96 mass %) without forming the coating 3 on base substrate 2. Evaluation results of the comparative samples of electronic device 10 are shown in the column “Comparative Example 1” in FIG. 6.

### Evaluations

### Evaluation of the ESD Immunity

Values of the ESD breakdown voltage and the ESD breakdown current density of the electronic devices 10 produced for evaluation were confirmed according to the following method.

First, according to the electrostatic discharge immunity test (AEC-Q200), a voltage was applied across the electrodes 12 of the electronic device produced for evaluation while increasing the voltage in increments of 0.5 kV, and the value of the voltage at which the resistive element 14 was broken (the ESD breakdown voltage) was measured. The results are shown in FIG. 6.

The value of the current density when the resistive element 14 was broken (the ESD breakdown current density) was measured. The results were compared with the measured results of Comparative Example 1. The comparison results according to the following criteria are shown in FIG. 6.
A: Exhibited an extremely higher ESD current density the Comparative Example 1.
B: Exhibited a higher ESD current density than Comparative Example 1.
C: Exhibited almost the same ESD current density as the Comparative Example 1.

Comparing the Examples and the Comparative Example 1, it was confirmed that the ESD immunity of the electronic device 10 is increased by covering the sintered alumina substrate with the coating 3. It was confirmed that the ESD immunity of the electronic device 10 is more increased by using, as the method of applying the coating liquid (X), the application method using a squeegee or the application method using a spin coater.

### Modification Example

Modification examples of the ceramic substrate 1 will be described below. The modification examples are variations made by partly changing, adding, or deleting the configurations of the embodiment.

Use of the ceramic substrate 1 may not be limited to the use for producing the electronic device 10. The ceramic substrate 1 may be used to produce at least one selected from the group consisting of, for example, heat dissipation components, industrial heat-resistant and chemically resistant components, wear-resistant parts, and electrical insulating parts.

The base substrate 2 may not be limited to the sintered alumina substrate. In other words, the ceramic particles (A) may include, in addition to the alumina particles (A1), inorganic particles of at least one selected from the group consisting of, for example, aluminum nitride (AlN), zirconia (ZrO₂), and silicon nitride (Si₃Ni₄). In still other words, the base substrate 2 may include, in addition to the sintered body of the alumina particles (A1), a sintered body of inorganic particles of at least one selected from the group-consisting of, for example, aluminum nitride, aluminum nitride, and silicon nitride.

The coating liquid (X) may contain an additive in addition to the α-alumina particles (B), the dispersant and the solvent used in the above-described embodiment. The additive may contain at least one selected from the group consisting of, for example, a binder resin, a sintering agent, and an antifoam agent.

The coating liquid (X) may contain a binder resin as described above. The coating liquid (X) containing the binder resin allows the viscosity of the coating liquid (X) to be adjusted. This allows the coating liquid (X) to be easily applied to the base substrate 2. The binder resin may contain at least one selected from the group consisting of, for example, an acrylic resin and a cellulose resin.

The coating liquid (X) may contain a sintering agent. The coating liquid (X) containing the sintering agent enhances the sinterability of the α-alumina particles (B). The sintering agent may contain at least one selected from the group consisting of, for example, calcium oxide (CaO), magnesium oxide (MgO), titanium dioxide (TiO₂), manganese oxide (Mn), strontium oxide (SrO), barium oxide (BaO), and yttrium oxide (Yb₂O₃).

The method of producing the coating 3 on the surface of the base substrate 2 may not be limited to the method of using the coating liquid (X). The methods that can be used to dispose the α-alumina particles (B) on the surface of the base substrate 2 include, for example, a method using a cold spray and an aerosol deposition method.

### Aspects

As shown in the above embodiment, the present disclosure includes the following aspects. In the following aspects, the reference marks are shown only for the purpose of clearly showing the correspondences of the elements to those of the exemplary embodiment.

A ceramic substrate (1) in accordance with a first aspect includes: a base substrate (2) including a sintered body of ceramic particles (A); and a coating (3) including a sintered body of α-alumina particles (B). The coating (3) covers at least a part of a surface of the base substrate (2). An average particle size of the α-alumina particles (B) is smaller than an average particle size of the ceramic particles (A).

According to this aspect, a ceramic substrate (1) having a high thermal conductivity and a high surface smoothness is provided.

In a ceramic substrate (1) in accordance with a second aspect, according to the first aspect, the ceramic particles (A) include alumina particles (A1).

According to this aspect, the base substrate (2) has a high thermal conductivity, hence increasing the thermal conductivity of the ceramic substrate (1).

In a ceramic substrate (1) in accordance with a third aspect according to the first or second aspect, the coating covers at least one of plural recesses (21) provided in the surface of the base substrate (2).

According to this aspect, the surface smoothness of the ceramic substrate (1) is enhanced.

In a ceramic substrate (1) in accordance with a fourth aspect according to any of the first to third aspects, a part of the surface of the base substrate (2) is not covered with the coating (3).

According to this aspect, the high thermal conductivity possessed by the base substrate (2) itself is exerted. Therefore, the thermal conductivity of the ceramic substrate (1) is more increased.

In a ceramic substrate (1) in accordance with a fifth aspect according to any of the first to fourth aspects, the coating (3) has a crack (31) therein. A depth of the crack (31) in a thickness direction of the base substrate (2) is smaller than a maximum length of the α-alumina particles (B).

According to this aspect, the surface smoothness of the ceramic substrate (1) is adequately secured. Therefore, the ceramic substrate (1) is provided with a high ESD immunity.

In a ceramic substrate (1) in accordance with a sixth aspect according to any of the first to fifth aspects, a density of the coating (3) is smaller than a density of the base substrate (2).

According to this aspect, the balance of coarseness and fineness of the coating (3) is appropriately adjusted so that the density of the coating (3) may become smaller than the density of the base substrate (2). Therefore, the coating (3) may have an appropriate flexibility. This allows a stress generated in the ceramic substrate (1) to be easily alleviated by the coating (3) even when the stress is generated in the ceramic substrate (1).

In a ceramic substrate (1) in accordance with a seventh aspect according to any of the first to sixth aspects, the coating (3) is produced by firing the α-alumina particles (B) on the surface of the base substrate (2). In other words, the coating (3) contains α-alumina particles (B) having been fired on the surface of the base substrate (2).

According to this aspect, the thermal conductivity of the ceramic substrate (1) is adequately increased, and the surface smoothness of the ceramic substrate (1) is adequately enhanced.

A method for manufacturing a ceramic substrate (1) in accordance with an eighth aspect is a method for manufacturing the ceramic substrate (1) according to any of the first to seventh aspects, and includes: disposing the α-alumina particles (B) on the surface of the base substrate (2); and firing the α-alumina particles (B).

According to this aspect, a ceramic substrate (1) with a high thermal conductivity and a high surface smoothness is provided.

In a method for manufacturing a ceramic substrate (1) in accordance with a ninth aspect according to the eighth aspect, the α-alumina particles (B) is disposed on the surface of the base substrate (2) by applying coating liquid (X) containing the α-alumina particles (B) to the surface of the base substrate (2) with a squeegee.

According to this aspect, the ceramic substrate (1) is provided with a high ESD immunity.

### REFERENCE MARKS IN THE DRAWINGS

1 ceramic substrate
2 base substrate
3 coating
21 recess
22 pore
23 uncovered part
31 crack

1. A ceramic substrate comprising:
a base substrate including a sintered body of ceramic particles; and
a coating including a sintered body of α-alumina particles, wherein
the coating covers at least a part of a surface of the base substrate, and
an average particle size of the α-alumina particles is smaller than an average particle size of the ceramic particles.

2. The ceramic substrate according to claim 1, wherein the ceramic particles include alumina particles.

3. The ceramic substrate according to claim 1, wherein the coating covers at least one of plural recesses provided in the surface of the base substrate.

4. The ceramic substrate according to claim 1, wherein the surface of the base substrate includes a part that is not covered with the coating.

5. The ceramic substrate according to claim 1, wherein
the coating has a crack therein, and
a depth of the crack in a thickness direction of the base substrate is smaller than a maximum length of the α-alumina particles.

6. The ceramic substrate according to claim 1, wherein a density of the coating is smaller than a density of the base substrate.

7. The ceramic substrate according to claim 1, wherein the coating contains α-alumina particles that have been fired on the surface of the base substrate.

8. A method for manufacturing the ceramic substrate according to claim 1, the method comprising:
disposing the α-alumina particles on the surface of the base substrate; and
firing the α-alumina particles disposed on the surface of the base substrate.

9. A method according to claim 8, wherein said disposing the α-alumina particles on the surface of the base substrate comprises applying coating liquid containing the α-alumina particles to the surface of the base substrate with a squeegee.
